(19) United States
(12) Patent Application Publication
(10) Pub. No.: US 2024/0111894 A1
(43) Pub. Date: Apr. 4, 2024

(54) GENERATIVE MACHINE LEARNING MODELS FOR PRIVACY PRESERVING SYNTHETIC DATA GENERATION USING DIFFUSION

(71) Applicant: NVIDIA Corporation, Santa Clara, CA (US)

(72) Inventors: Karsten Julian KREIS, Vancouver (CA); Tim DOCKHORN, Waterloo (CA); Tianshi CAO, Toronto (CA); Arash VAHDAT, Mountain View, CA (US)

(73) Assignee: NVIDIA Corporation, Santa Clara, CA (US)

(21) Appl. No.: 18/164,215

(22) Filed: Feb. 3, 2023

Related U.S. Application Data
(60) Provisional application No. 63/410,887, filed on Sep. 28, 2022.

(51) Int. Cl. G06F 21/62; G06N 3/0455

(52) U.S. Cl. CPC G06F 21/6245; G06N 3/0455

(57) ABSTRACT

In various examples, systems and methods are disclosed relating to differentially private generative machine learning models. Systems and methods are disclosed for configuring generative models using privacy criteria, such as differential privacy criteria. The systems and methods can generate outputs representing content using machine learning models, such as diffusion models, that are determined in ways that satisfy differential privacy criteria. The machine learning models can be determined by diffusing the same training data to multiple noise levels.

### CROSS-REFERENCE TO RELATED APPLICATIONS

The present application claims priority to U.S. Provisional Patent Application No. 63/410,887, filed Sep. 28, 2022, the disclosure of which is incorporated herein by reference in its entirety.

### BACKGROUND

Content generation systems, including machine learning models, can rely on training data that may indicate information regarding entities associated with the training data. As an example, some generative models may be trained using training data that includes images of people. It can be useful for the content generation systems to generate content or other outputs that meet privacy criteria, such as to provide at least a threshold level of privacy so that information regarding the entities cannot be reconstructed or inferred from the output of the content generation systems. However, it can be difficult to configure the content generation systems to meet both the privacy criteria and performance criteria, such as criteria for quality of the generated content.

### SUMMARY

Embodiments of the present disclosure relate to using differentially private machine learning models—such as models that can implement differential privacy protection for image or other content generation applications—for training and updating generative models. Systems and methods are disclosed for generative models, including diffusion models for example, that implement privacy with respect to the training data used to train or update the generative models.

In contrast to conventional systems, such as those described above, systems and methods in accordance with the present disclosure can allow for better quality of generated content, including but not limited to images, while meeting privacy criteria. For example, together with implementing differentially private stochastic gradient descent (DP-SGD), for a given iteration of training or updating the model, each training data element can be diffused to multiple times selected from a time interval, which can reduce overall stochasticity/noise without using up the privacy training budget. The time intervals from which noise perturbations are selected can be configured to specifically target low-frequency or high-frequency details. Combinations of public and private data can be used to perform portions of the training/updating to facilitate achieving both quality and privacy criteria.

At least one aspect relates to a processor. The processor can include one or more circuits that can be used to generate, using a neural network and based at least on receiving an indication of one or more features, an output corresponding to the one or more features, wherein the neural network is updated according to at least one privacy criterion. The one or more circuits can be used to cause, using at least one of a display or an audio speaker device, presentation of the output.

In some implementations, the neural network may include a diffusion model updated using at least a first training data point determined by applying noise with respect to a first duration of time (e.g., a first amount of noise) to a training data instance, and a second training data point determined by applying noise with respect to a second duration of time (e.g., a second amount of noise) to the training data instance. In some implementations, the neural network is updated using a gradient descent operation that modifies gradient values using noise. In some implementations, the neural network is a denoising network to generate the output by determining an initial output according to the indication of the one or more features, modifying the initial output for a plurality of iterations up to a predetermined denoising level to determine an intermediate output, and determining the output in a single iteration according to the intermediate output. In some implementations, the at least one privacy criterion corresponds to a restriction on iterations of updating the network.

In some implementations, the output includes at least one of text data, speech data, or image data. In some implementations, the indication includes text instructions for incorporating the one or more features into the at least one of the text data, the speech data, or the image data.

At least one aspect relates to a processor. The system can include one or more circuits that can be used to determine a plurality of estimated outputs using a neural network and based at least on processing a first training data point and a second training data point. The one or more circuits can be used to determine the first training data point by applying noise to a training data instance with respect to first duration of time, and can determine the second training data point by applying noise to the training data instance with respect to a second duration of time. The processing units can be used to update one or more parameters of the neural network based at least on (i) comparing the plurality of estimated outputs to a sample output corresponding to the training data instance, and (ii) at least one privacy criterion.

In some implementations, the one or more circuits can update the one or more parameters using a gradient descent operation that modifies gradient values using noise. In some implementations, the at least one privacy criterion corresponds to a restriction on iterations of updating the neural network.

In some implementations, the training data instance is a first training data instance, and a first training data set includes the first training data instance; the one or more circuits can update the neural network using a plurality of second training data instances of a second training data set separate from the first training data set.

In some implementations, the one or more circuits can apply an autoencoder to provide the training data instance in a latent data space. The one or more circuits can provide the training data instance from the latent data space to the neural network.

In some implementations the neural network includes a diffusion model. In some implementations, the one or more circuits can select the first duration of time and the second duration of time according to a predetermined distribution indicative of at least one of time or noise level.

In some implementations, the one or more circuits can identify the predetermined distribution from a plurality of distributions according to the at least one privacy criterion. In some implementations, the predetermined distribution extends between a minimum value that is greater than zero and a maximum value.

At least one aspect relates to a method. The method can include generating, using a neural network and based at least on receiving an indication of one or more features, an output corresponding to the one or more features. The neural network can be selected according to at least one privacy criterion. The method can include causing, by the one or more processors using at least one of a display or an audio speaker device, presentation of the output.

In some implementations, the neural network includes a diffusion model determined using at least a first training data point determined by applying a first amount of noise to a training data instance and a second training data point determined by applying a second amount of noise to the training data instance. In some implementations, the output includes at least one of text data, speech data, or image data.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for machine learning models for generating differentially private content are described in detail below with reference to the attached drawing figures, wherein:

FIG. 1 is a block diagram of an example differentially private model generation system, in accordance with some embodiments of the present disclosure;

FIG. 2 is a block diagram of an example differentially private content generation system, in accordance with some embodiments of the present disclosure;

FIG. 3 is a flow diagram of an example of a method for differentially private content generation, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to machine learning models that implement privacy protection techniques with respect to the training data used to train or update the models. For example, the models can be generative models, such as diffusion models, that are trained or updated using techniques such as differentially private stochastic gradient descent. Privacy protections may be implemented in models by adding or injecting noise that modifies potentially sensitive data, or otherwise causes the data to be incapable of being specifically associated to, or recognizable as individuals. However, it can be difficult to configure the models to have sufficient performance with respect to image quality when the training data is augmented with injected noise. Generative adversarial network (GAN) models, for example, may be unstable to train, which can be exacerbated by the noise. In addition, deep learning models often rely on large amounts of training data in order to be trained to a point that satisfies performance criteria; however, models may often be overfit, overparameterized, or otherwise configured so that the training data (e.g., text and/or images) may be readily recovered/inferred from the model, providing little to no privacy. For example, some generative models may be capable of outputting data indistinguishable from (or mimicking certain characteristic features or traits of) the training data.

Systems and methods in accordance with the present disclosure can configure (e.g., train, implement, establish, etc.) models to have improved quality while retaining target privacy criteria. The models can be trained or updated using privacy criteria, such as by performing differentially private stochastic gradient descent (DP-SGD), which may include clipping and injecting, augmenting, or applying noise to one or more of the gradients of parameters of the models during training to prevent the models from being capable of direct reproduction of the training data. By using diffusion models, which can perform denoising iteratively, the denoising can be performed more effectively in the context of DP-SGD (e.g., as compared with GANs).

The models can be trained/updated using classifier-free guidance, such as by using classifications of training data elements for a subset of the training, and not for a remainder of the training. In one or more embodiments, the models can be diffusion models, which are trained and/or updated by iteratively diffusing (e.g., applying noise to) each training data element up to a time t, and training a model (e.g., a network, such as a denoising network) to be capable of removing noise from the diffused training data elements. For a given iteration, each training data element can be diffused to one or multiple times selected from a time interval, which can reduce overall stochasticity/noise without depleting or using up the privacy training budget. For example, a first sample of a training data element can be diffused to a first time (e.g., duration of length of time) selected from the time interval, and a second sample of the training data element can be diffused to a second time selected from the time interval.

The time interval (e.g., time distribution), which relates to the amount of noise perturbation of the training data elements for diffusion, can be selected or configured for various privacy targets; for example, distributions having relatively greater amounts of higher time values can be targeted to global low-frequency details, while distributions having relatively greater amounts of lower time values can be targeted to high-frequency fine details.

In some implementations, the time interval is configured to have a cutoff (e.g., floor) at a low noise level, which can improve computational efficiency since it can be challenging under differential privacy constraints to learn fine-grained denoising at relatively low times/noise levels. As such, during deployment, the denoising can proceed iteratively up to the cutoff (e.g., using the scope of the model's training where it has been effectively trained), and then be completed to a final output from the cutoff point (e.g., one-shot denoised to the final output). In some implementations, public data, which may be more readily available than private data, is used to perform the training for times below the cutoff.

Various combinations of public and/or private data can be used to perform aspects of the training. For example, public data can be used to pre-train the model, and private data (e.g., application-specific data) can be used to update the model, such as by updating a subset of parameters of the model or all parameters of the model.

In some implementations, an autoencoder can be implemented together with the diffusion models. For example, the autoencoder can be trained and/or updated using a first set of training data, such as public data, to convert the public data into a compressed latent data space, which can make downstream training more efficient (e.g., using less memory and/or computing resources). The diffusion models can be trained using the converted public data and/or private data, including but not limited to implementations in which the public data is converted into the compressed latent data space, subsequent to which the diffusion model is pre-trained using the converted public data, subsequent to which the diffusion model is updated (e.g., fine-tuned) using a second training data set, such as a private training data set.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implemented at least partially in a data center, systems for performing conversational AI operations, systems for performing light transport simulation, systems for performing collaborative content creation for 3D assets, systems implemented at least partially using cloud computing resources, and/or other types of systems.

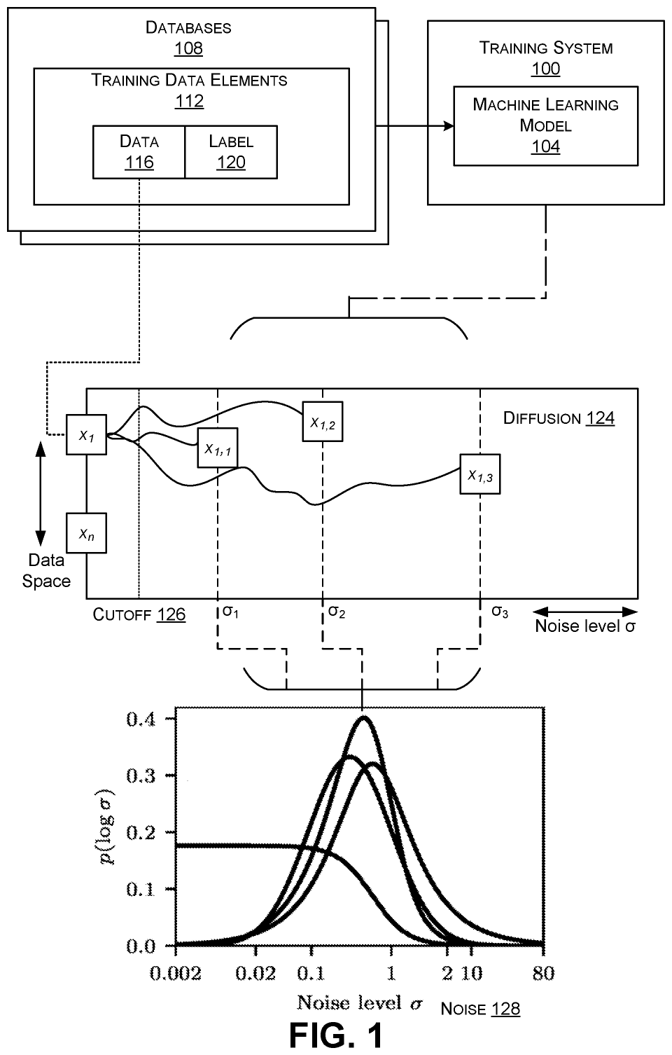

With reference to FIG. 1, FIG. 1 is an example computing environment including a training system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The training system 100 can include any function, model (e.g., machine learning model), operation, routine, logic, or instructions to perform functions such as configuring machine learning models 104 as described herein.

The training system 100 can train, update, or configure one or more machine learning models 104. The machine learning model 104 may include one or more neural networks. The neural network can include an input layer, an output layer, and/or one or more intermediate layers, such as hidden layers, which can each have respective nodes. The training system 100 can train/update the neural network by modifying or updating one or more parameters, such as weights and/or biases, of various nodes of the neural network responsive to evaluating candidate outputs of the neural network.

The machine learning models 104 can be or include various neural network models, including models that are effective for operating on or generating data including but not limited to text or speech data, such as natural language representations, image data, video data, or various combinations thereof. The machine learning model 104 can include one or more transformers, recurrent neural networks (RNNs), long short-term memory (LSTM) models, other network types, or various combinations thereof. The RNNs can use internal state data to process inputs of various lengths, including natural language data representations, such as using outputs of nodes to affect subsequent inputs to those nodes. The LSTMs can have gating elements to facilitate retaining values of data in memory over various iterations of operation of the LSTMs. The machine learning models 104 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

For example, the machine learning models 104 can include at least one diffusion model. The diffusion model can be a continuous time diffusion model. The diffusion model can include a network, such as a denoising network. For example, in brief overview, the diffusion model can include a network that is trained, updated, and/or configured using training data that includes data elements to which noise is applied, and configuring the network to modify the noise-augmented data elements to recover the (un-noised) data elements. The network can have a relatively small number of parameters, such as on the order of 10⁶ parameters (e.g., compared with models that use 10⁹ or more parameters, which may not result in models that can meet differential privacy criteria).

Referring further to FIG. 1, the training system 100 can operate on one or more training data elements 112 (e.g., training data instances), which may be retrieved from one or more databases 108. The one or more databases 108 can be maintained by one or more entities, which may be entities that maintain the training system 100 or may be separate from entities that maintain the training system 100. In some implementations, the training system 100 uses training data from different data sets, such as by using training data elements 112 from a first database 108 to perform at least a first configuring of the machine learning model 104, and uses training data elements from a second database 108 to perform at least a second configuring of the machine learning model 104. For example, the first database 108 can include publicly available data, while the second database 108 can include data having at least some privacy or access restrictions; by using the data of the first database 108 to perform at least the first configuring of the machine learning model 104, the training system 100 can more effectively satisfy both performance criteria and privacy criteria for the machine learning model 104.

The training data elements 112 include data 116. According to one or more embodiments, the data 116 can include, without limitation, text, speech, audio, image, and/or video data. The training system 100 can perform various pre-processing operations on the data 116, such as filtering, normalizing, compression, decompression, upscaling or downscaling, cropping, and/or conversion to grayscale (e.g., from image and/or video data 116). Images (including video) of the data 116 can correspond to at least one of images of a subject, such as a person or object, captured by an image capture device (e.g., camera), or images generated computationally (which may be representative of a subject, including by being modifications of images from an image capture device). The images can each include a plurality of pixels, such as pixels arranged in rows and columns. The images can include image data assigned to one or more pixels of the images 116, such as color, brightness, contrast, intensity, depth (e.g., for three-dimensional (3D) images), or various combinations thereof. In some implementations, the images can have relatively low resolution, such as to be on the order of tens or hundreds (e.g., rather than thousands) of rows and columns.

In some implementations, at least one training data element 112 is associated with a label 120. For example, labels 120 can be assigned to training data elements 112 in the database 108. The labels 120 may correspond to at least one of user input or automated labeling of data 116. The labels 120 may indicate identifiers of features represented by the data 116, such as categories, classifications or classes of objects represented by the data 116 (e.g., in images), or semantic context of text or speech data.

Referring further to FIG. 1, the training system 100 can configure the machine learning model 104 by applying noise to the data 116 of training data elements 112 to generate modified data, and modifying the machine learning model 104 to meet one or more criteria associated with (i) outputs of the machine learning model 104 generated responsive to receiving the modified data as input and (ii) the data 116. For example, the training system 100 can use differentially private stochastic gradient descent (DP-SGD) to update the machine learning model 104 according to the outputs and the data 116.

As depicted in FIG. 1, the training system 100 can perform diffusion 124 on the data 116. The training system 100 can perform diffusion 124 by applying noise to (e.g., diffusing) a plurality of data 116 of training data elements 112, to determine training data points (e.g., diffused or noised data). For example, the training system 100 can add the noise to the data 116 (e.g., add a numerical value representing the noise in a same data format as the data 116, to the data 116) to determine the training data points.

In some implementations, the training system 100 performs the diffusion 124 using the data 116, and the labels 120 correspond to respective data 116, such as to perform classifier-based guidance and/or at least some classifier-free guidance. For example, the at least one machine learning model 104 can include or be coupled with a classifier that the training system 100 can configure to determine labels 120 responsive to receiving inputs of data 116. The training system 100 can determine an output of the classifier, such as a gradient or other data element representative of estimated class(es) from the classifier, and can apply the output to configure the machine learning model 104, such as to the gradient produced by the machine learning model 104 (e.g., before or after clipping and adding noise to the gradient outputted by the machine learning model 104). In some implementations, the training system 100 uses the classifier for training with the data 116, and does not use the classifier for a subset of data 116. For example, for the subset of data 116, the training system 100 can discard or otherwise not provide the labels 120 corresponding to the data 116, or can substitute a nominal label which may indicate that for the subset of data 116 the classifier is not to be used (e.g., training is not to be performed conditioned on the labels 120).

According to one or more embodiments of the present disclosure, the noise can be a sample of a distribution, such as a Gaussian distribution. The training system 100 can apply the noise according to or with respect to a duration of time t. The duration of time t can be a value in a time interval, such as a value between zero and a maximum T of the time interval. The duration of time t may be a multiple of a number of discrete time steps between zero and T. The maximum T may correspond to an amount of time such that the result of applying noise for a duration of time T may be indistinguishable or almost indistinguishable from Gaussian noise. The training system 100 can apply noise corresponding to a value of the duration of time t randomly selected from the time interval. In some implementations, applying noise according to the duration of time t can correspond to or be equivalent to applying a noise level a to the data 116 to determine (e.g., generate, output) the training data point.

In some implementations, the training system 100 performs various operations described herein, including but not limited to diffusion 124 and configuring of the machine learning model 104, on batches of data 116 of the plurality of training data elements 112. For example, there may be a relatively larger number N of training data elements 112, and the training system 100 can sample data 116 from the N training data elements 112 to identify a subset of data 116, such as a batch B of data 116. The training system 100 can sample the data 116 to identify the subset (e.g., identify the batch) using Poisson sampling.

As depicted in FIG. 1, the training system 100 can perform the diffusion 124 according to one or more noise distributions 128. The noise distributions 128 can be predetermined distributions or functions, such as probability functions or predetermined probability distribution functions, indicating a probability of various noise levels σ. The noise level a can represent a statistical characteristic of noise to apply to data 116, such as a standard deviation of a distribution (e.g., Gaussian distribution) from which the noise can be retrieved according to the noise level σ. For each instance of applying noise to data 116, the training system 100 can (randomly) select a noise level a from a noise distribution 128, and can apply noise corresponding to the selected noise level a to the data 116. For example, the training system 100 can determine the noise to apply by sampling the noise from a distribution having a standard deviation of σ, and modifying (e.g., adding, perturbing, etc.) the value(s) of the data 116 using the sampled noise. The one or more noise distributions 128 may include/have varying distribution shapes, as depicted in FIG. 1, enabling the training system 100 to focus training on fine details (e.g., using a noise distribution 128 with relatively greater likelihood of low noise levels σ) or low frequency details (e.g., using a noise distribution 128 with relatively lower likelihood of high noise levels σ).

In one or more embodiments, the training system 100 can implement noise multiplicity operations that diffuse various data 116 to various noise levels σ to determine multiple training data points (e.g., multiple data points of diffused data 116). For example, the training system 100 can determine, for each of one or more data 116, a plurality of training data points (e.g., modified values of data 116) by applying noise to the data 116 using a plurality of noise levels σ, such as to apply noise to the data 116 with respect to a plurality of durations of time. In some implementations, the training system 100 can determine at least a first training data point by applying a first noise level a to the data 116 and a second training data point by applying a second noise level a to the data 116; the first noise level a and the second noise level a may be different, and may be indicative of diffusing the data 116 for different durations of time (e.g., different durations of time t and/or time steps between zero and T). The training system 100 can select the first noise level σ and second noise level σ from the same noise distribution 128 or different noise distributions 128. As depicted in FIG. 1, for example, the training system 100 can determine k=3 training data points from the data x₁, such as to determine a first training data point x_{1,1} by applying a first noise level σ₁ to the data x₁, a second training data point x_{1,2} by applying a second noise level σ₂ to the data x, and a third training data point x_{1,3} by applying a third noise level σ₃ to the data x. The training system 100 can determine multiple training data points k for each of a plurality of data 116, such as for data x₁, x₂, . . . xₙ (the training data points determined by applying noise to data xₙ are not depicted in FIG. 1 for clarity).

The training system 100 can configure (e.g., train, modify, update, etc.) the machine learning model 104 based at least on the training data points. For example, the training system 100 can use various objective functions, such as cost functions or scoring functions, to evaluate estimated (e.g., candidate) outputs that the machine learning model 104 determines (e.g., generates, produces) in response to receiving the training data points as input, and performing a comparison of the estimated outputs with the data 116 used to determine the training data points. For example, the training system 100 can use an objective function that performs a comparison of noisy images represented by the training data points with original images of the data 116. The training system 100 can update the machine learning model 104 responsive to the objective function, such as to modify the machine learning model 104 responsive to whether the comparison between the training data points and the corresponding data 116 satisfies various convergence criteria (e.g., an output of the objective function is less than a threshold output or does not change more than a predetermined value over a number of iterations; a threshold number of iterations of training is completed; the machine learning model 104 satisfies performance criteria (e.g., with respect to output quality, accuracy of a downstream classifier operating on the output of the machine learning model 104, etc.) and privacy criteria). The objective function can include, for example and without limitation, a least squares function, an L1 norm, or an L2 norm. The objective function can receive, as input, at least (1) the estimated output of the machine learning model 104 determined responsive to the training data point (e.g., x_{1,1}) and (2) the data 116 (e.g., x₁) used to determine the training data point, and can determine an objective value as output responsive to the input. The objective function can receive the noise level σₖ used to determine the training data point, enabling the machine learning model 104 to be trained by conditioning on the noise level σₖ. By implementing noise multiplicity, the training system 100 can facilitate more effective training of the machine learning model 104 without incurring privacy costs.

In some implementations, to evaluate processing by the machine learning model 104 of a training data point xᵢ (e.g., from diffusion of a given data 116, such as a given image), the training system 100 uses the objective function:

lᵢ=λ(i)∥D_{θ}(xᵢ+nᵢ,σᵢ)−xᵢ∥₂²

where xᵢ is the data 116; σ₁ is the noise level selected for applying noise nᵢ to the data xᵢ; D_{θ} is the denoising network represented by the machine learning model 104 having parameters (e.g., weights and/or biases) θ (such that the estimated output of the machine learning model 104 corresponds to D_{θ}(xᵢ+nᵢ, σᵢ)); and λ(σᵢ) is a weighting parameter (e.g., for conditioning on the noise level σᵢ).

The training system 100 can evaluate the objective function for each training data point of the plurality of training data points (e.g., x_{1,1}, x_{1,2}, and x_{1,3} depicted in FIG. 1) by combining the objective values outputted by the objective function for each training data point. For example, the training system 100 can determine, for data xᵢ, an average of the objective values of the plurality of training data points (where the inputs to the machine learning model 104 are shown explicitly):

$${\tilde{l}}_{i} = \frac{1}{K} {\sum }_{k = 1}^{K} λ ( {σ}_{i k} ) ‖ {D}_{θ} ( {x}_{i} + {n}_{ik} , {σ}_{i k} ) - {x}_{i} ‖ \begin{matrix}2 \\ 2\end{matrix}$$

By combining the objective values from the plurality of training data points into a single value (e.g., average value) that can be used for further processing, such as determining gradients, the training system 100 can capture greater information from the data 116 (which can allow improved quality of the output of the machine learning model 104 when trained) without reducing privacy (e.g., without using up a privacy budget).

The training system 100 can apply various machine learning model optimization or modification operations to modify the machine learning model 104 responsive to the outputs of the objective function. For example, the training system 100 can use a gradient descent operation, such as stochastic gradient descent. The training system 100 can implement a modification operation that satisfies one or more privacy criteria, such as to satisfy differential privacy criteria. For example, the training system 100 can apply differential privacy stochastic gradient descent (DP-SGD).

The training system 100 can determine the gradient as:

g_{θ}=∇_{θ}\hat{l}ᵢ

The training system 100 can clip (e.g., modify the value of the gradient to be within a predetermined range responsive to the gradient being outside of the predetermined range; for example, the predetermined range may be from −1 to 1, and responsive to the value of the gradient being less than −1 or greater than 1, the clipping can modify the value to be −1 or 1, respectively) and/or apply noise to the gradient, which can allow the training system 100 to meet privacy criteria, such as differential privacy criteria. For example, the training system 100 can modify the gradient as:

g_{θ}^{DP}=clip_{C}(g_{θ})+Cz,z˜(0,σ_{DP}²I)

where z represents the noise added (which may be distinct from the noise used to diffuse the data 116), and C is a clipping constant. For example, to update the parameters θ of the machine learning model 104, the training system 104 can perform an update:

θ←θ−η/B(Σ_{i∈B}clip_{C}(∇_{θ}lᵢ(θ))+Cz),z˜N(0,σ_{DP}²I)

where η can be a learning rate for updating of the machine learning model 104, and B indicates a batch of data 116.

In some implementations, the training system 100 can meet at least one differential privacy criteria (ε, δ)-DP, which can be indicative of the data 116 not being capable of being recovered from the machine learning model 104 or the outputs thereof. For example, the differential privacy criteria (ε, δ)-DP can be represented by:

Pr[M(d)∈S]≤e^{ε}Pr[M(d′)∈S]+δ

where d and d′ represent data sets that differ by at most one entry, M represents a mechanism (e.g., a randomized mechanism), S represents at least a subset of outputs of M, ε corresponds to a metric of privacy loss (e.g., relative to a change in the data, such as adding or removing an entry, where smaller ε corresponds to greater privacy; F may be a controllable parameter), and δ corresponds to a likelihood of privacy leak. For example, the machine learning model 104 and/or an update to the machine learning model 104 can satisfy the differential privacy criteria where σ_{DP}² (e.g., the variance representing noise used for modifying the gradients of the machine learning model 104) is greater than 2 log(1.25/δ)C²/ε². The differential privacy criteria can correspond to a restriction on iterations of training the machine learning model 104 (e.g., iterations of updating the machine learning model 104 using data 116 or batches of data 116), such as a restriction indicative of a privacy budget. For example, one or more iterations of training the machine learning model 104 can correspond to a (marginal) use of at least one of δ or ε; the privacy budget may be a total threshold value of at least one of δ or ε to be summed over each training iteration. Examples of ε values may include, without limitation, 0.2 (e.g., high privacy), 1 (e.g., moderate privacy), or 10 (e.g., low privacy).

Referring further to FIG. 1, the training system 100 can use noise levels σ and/or noise distributions 128 to more effectively target relatively low or relatively high noise training. For example, for high privacy settings (e.g., relatively low values of F), it may be useful for the training system 100 to use a noise distribution 128 that has a relatively greater proportion of high noise levels σ (or vice versa for relatively lower privacy settings). This can allow the training system 100 to focus training of the machine learning model 104 on coarse, global, and/or low frequency features in order to satisfy both performance (e.g., image quality) and privacy criteria. In some implementations, at least one noise distribution 128 has a median noise level σ that is greater than or equal to a threshold, such as greater than or equal to a value between about 0.1 and about 10. In some implementations, the threshold is between about 0.5 and about 5.

In some implementations, the training system 100 applies a cutoff 126 (e.g., ceiling) to the noise distribution 128. The cutoff 126 can have a relatively low noise level value, which can allow the training system 100 to prevent diffusion of data 116 to relatively low noise levels. For example, the training system 100 can modify the noise distribution 128 to have fewer or no noise levels σ less than the cutoff 126, or the training system 100 can discard or otherwise not use noise levels σ less than the cutoff 126 that are sampled from the noise distribution 128 when determining training data points (e.g., x_{1,1}, etc.) from data 116 (e.g., x₁). For example, the training system 100 can select the noise distribution 128 or modify the noise distribution 128 so that the noise distribution 128 extends between a minimum value that is greater than zero and a maximum value, such that sampling the noise distribution 128 can return values that are greater than or equal to the minimum value and less than or equal to the maximum value. As depicted in FIG. 1, at least some noise distributions 128 may have relatively low probabilities of noise levels σ being sampled that have relatively low values (in which case the cutoff 126 may not necessarily be used by the training system 100 to perform a separate operation from sampling the noise distribution 128).

In some implementations, the training system 100 uses at least some different subsets of the data 116 to configure the machine learning model 104 relative to noise levels σ that are greater than the cutoff 126 as compared to noise levels that are less than the cutoff 126. For example, the training system 100 can use first data 116 (e.g., a first subset of the data 116) to configure the machine learning model 104 for noise levels σ greater than the cutoff 126, and second data 116 (e.g., a second subset of the data 116) to configure the machine learning model 104 for noise levels σ less than the cutoff 126. At least some of the first data 116 may be data for which privacy criteria are to be met, while at least some of the second data 116 can be data for which privacy criteria are not necessary to be met (and as such may be mutually exclusive with the at least some of the first data 116 for which privacy criteria is to be met). This can, for example, allow the training system 100 to pre-train the machine learning model 104 using public data (e.g., data for which privacy criteria are not necessary) for noise levels σ less than the cutoff 126, and fine-tune the machine learning model 104 using private data (e.g., data of which at least a subset implicates privacy criteria) for noise levels σ greater than the cutoff 126. In some implementations, the training system 100 trains the machine learning model 104 using the public data without implementing privacy criteria, or retrieves the machine learning model 104 as a pre-trained diffusion model trained on public data, and fine-tunes the machine learning model 104 using privacy criteria. As such, the training system 100 can more effectively meet both performance and privacy criteria.

In some implementations, the training system 100 includes or is coupled with a component to convert (e.g., compress) at least some of the data 116 into a latent space, such as an autoencoder. For example, the autoencoder can include an encoder (e.g., neural network encoder) configured to convert the data 116 from a first number of dimensions to a second number of dimensions less than the first number, and/or a decoder (e.g., neural network decoder) configured to convert the converted data from the second number of dimensions to the first number of dimensions (e.g., by training the decoder using comparisons of estimated outputs of the decoder with the original data 116). The training system 100 can train the diffusion model of the machine learning model 104 on the data 116 in the latent (e.g., compressed) space, which can allow for more effective training, particularly under differential privacy criteria. In some implementations, the autoencoder is applied to at least some public data 116, and the training system 100 can fine-tune the machine learning model 104 using private data 116 (e.g., with or without encoding the private data 116 into the latent space).

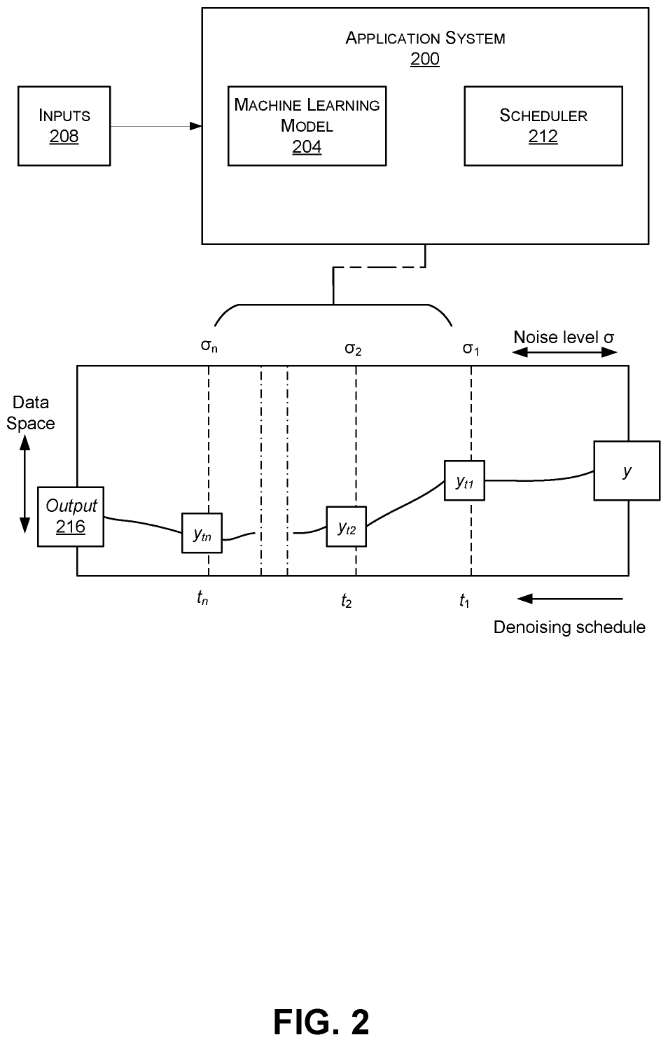

Now referring to FIG. 2, FIG. 2 depicts an example computing environment including an application system 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The application system 200 can include any function, model (e.g., machine learning model), operation, routine, logic, or instructions to perform functions such as deploying, updating, and/or generating outputs from machine learning models 204 as described herein. The application system 200 can incorporate features of the training system 100, such as to facilitate periodic updating or modifications of the machine learning models 204. The application system 200 can be implemented at least partially by the same or different entities or devices that implement the training system 100.

The application system 200 can include at least one machine learning model 204. The machine learning model 204 can include the machine learning model 104 of FIG. 1 or a representation thereof, such as the machine learning model 104 having been configured to meet differential privacy criteria. For example, in the application system 200, the machine learning model 204 can be a diffusion model that can generate outputs that meet differential privacy criteria with respect to the data 116 (see FIG. 1) used to configure the machine learning model 104, such as to satisfy various privacy criteria described herein. The diffusion model can also be capable of meeting performance criteria such as quality of outputs and/or accuracy of results of a classifier applied to the outputs. The machine learning model 204 can be received from the training system 100 of FIG. 1 as a data structure that includes the machine learning model 104 or a representation thereof, such as a data structure representing the structure of the machine learning model 104 (e.g., layers or arrangements of layers) or the parameters of the machine learning model 104. In some implementations, the application system 200 determines or generates the machine learning model 204 using a model backbone that includes one or more of: parameters of a denoising network (e.g., D_{θ} of machine learning model 104), weighting parameters (e.g., λ₀), and a noise distribution 128 (see FIG. 1).

The application system 200 can receive one or more inputs 208. The inputs 208 can indicate one or more features of output for the machine learning model 104 to generate. The inputs 208 can be received from one or more user input devices that may be coupled with the application system 200. The inputs 208 can include any of a variety of data formats, including but not limited to text, speech, audio, image, or video data indicating instructions corresponding to the features of output 216 for the machine learning model 104 to generate. For example, the inputs 208 can indicate, for example and without limitation, features to be include in output 216 such as styles, syntax, colors, subjects, or other subject matter or characteristics of subject matter to be generated as text, speech, audio, images, and/or video as the output 216. In some implementations, the application system 200 presents a prompt requesting the one or more features via a user interface, and receives the inputs 208 from the user from the user interface.

The application system 200 can include a scheduler 212. The scheduler 212 can control sampling of outputs of the machine learning model 204 responsive to the input 208. For example, the scheduler 212 can have a schedule of time points at which to sample the output of the machine learning model 204, such as to cause the machine learning model 204 to generate an output responsive to the input 208 based at least on a noise level corresponding to a respective time point of the schedule of time points. The time points may be of various arrangements, such as linear or nonlinear arrangements between a minimum value and maximum value.

The scheduler 212 can cause the machine learning model 204 to iteratively determine outputs based at least on the schedule and the input 208. For example, as depicted in FIG. 2, the scheduler 212 can cause the machine learning model 204 to determine a first output yₜ₁ at a first time point of the schedule responsive to an initial input y, determine a second output yₜ₂ at a second time point of the schedule responsive to the first output yₜ₁, determine an nth output yₜₙ at an nth time point of the schedule responsive to an n−1th output (e.g., the second output yₜ₂ or a further output corresponding to an iteration between the iterations for the nth output and the second output), and a (final) output 216 responsive to the nth output yₜₙ. The application system 200 can determine the input y as a random noise sample, and cause the machine learning model 204 to determine the output 216 according to the input 208 (e.g., to convert random noise y into an output 216 representative of the features indicated by the input 108).

In some implementations, the time point tₙ of the nth output can correspond to a noise cutoff used to configure the machine learning model 204, such as the noise cutoff 126 described with reference to FIG. 1, such that the machine learning model 204 can perform a plurality of iterations of output generation to determine the nth output yₜₙ, and subsequently one-shot denoise to the output 216. For example, a time difference between tₙ and the end time of the output 216 can be greater than a time difference between at least one prior pair of time points of the schedule. In some implementations, the nth time point corresponds to a noise level σ (such as the cutoff 126) at which different data 116 is used for configuring the machine learning model 204, such as in examples where private data 116 is used to configure the machine learning model 104 for noise levels σ greater than the noise level σ, and public data 116 is used to configure the machine learning model 104 for noise levels σ less than the noise level σ.

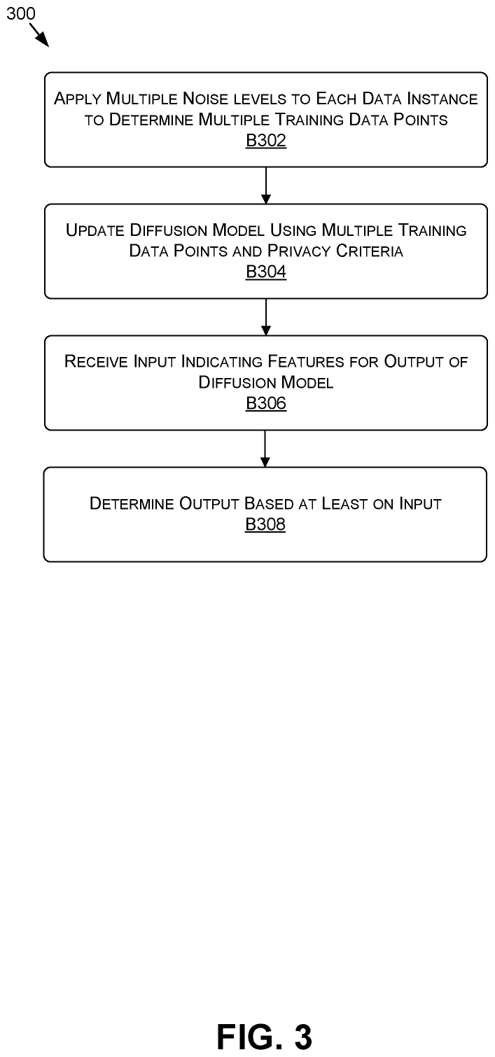

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1 and the process of FIG. 2. However, this method may additionally or alternatively be executed by any one system, or any combination of systems, including, but not limited to, those described herein.

FIG. 3 is a flow diagram showing a method 300 for generating images and other content using neural network models, such as diffusion models, in accordance with some embodiments of the present disclosure. Various operations of the method 300 can be implemented by the same or different devices or entities at various points in time. For example, one or more first devices may implement operations relating to configuring diffusion models, and one or more second devices may implement operations relating to receive user inputs requesting content to be generated and presenting or otherwise providing the content. The one or more second devices may maintain the diffusion models, or may access the diffusion models using, for example and without limitation, APIs provided by the one or more first devices.

The method 300, at block B302, includes applying multiple noise levels to each data instance (e.g., data of a training data instance) of a plurality of data instances. The data instances can be data representing various forms of content, including but not limited to text, speech, audio, image, and/or video. The data instances can include at least some data for which privacy criteria, such as differential privacy criteria, are to be met. For example, the data instances may include all private data, or may include at least some public data.

Applying the multiple noise levels can include applying a first amount of noise to a first data instance of the plurality of data instances to determine a first training data point, and applying a second amount of noise to the first data instance to determine a second training data point (and can include applying further amounts of noise to the first data instance to determine further training data points). The noise levels can be determined using a predetermined noise distribution. In some implementations, the predetermined noise distribution has a median noise level between about 1 and about 10 (e.g., where the noise level determined from the predetermined noise distribution represents a value of a standard deviation of a distribution, such as a Gaussian distribution, from which the amounts of noise to apply to the data instances can be sampled). In some implementations, determining the noise levels includes limiting selection of noise levels less than a cutoff threshold, such as by selecting the predetermined noise distribution as a distribution that has relatively low likelihood of sampling of noise levels less than the cutoff threshold and/or limiting sampling to noise levels greater than the cutoff threshold. In some implementations, different noise levels are used for private data as compared with public data; for example, relatively high noise levels may be selected for applying to private data, while relatively low noise levels (e.g., noise levels below the cutoff threshold) may be selected for applying to at least some of the public data. An autoencoder may be used to convert at least some of the data instances into a latent space, which may facilitate more effective training to satisfy privacy criteria.

The method 300, at block B304, includes updating a machine learning model, such as a denoising network of a diffusion model, based at least on the plurality of training data points. For example, an objective function, such as a cost function or loss function, can be evaluated using an estimated output of the machine learning model, such as an objective function that performs a comparison between the estimated output and corresponding training data points. The objective values from evaluation of the objective function with respect to the multiple training data points can be combined, such as to be averaged, which can facilitate effective training or updating of the machine learning model without incurring a privacy cost from using multiple training data points. In some implementations, labels or annotations (which may indicate classes or categories of respective data instances) are used to configure a classifier together with the diffusion model. In some implementations, at least some classifier-free guidance is performed, such as by avoiding the use of the classifier for at least some of the data instances.

In some implementations, an optimization process, such as DP-SGD, can be applied to the machine learning model to update the machine learning model. For example, a gradient of the combined objective values can be determined, and can be at least one of clipped (e.g., restricted to a predetermined range) or modified using noise. The noise applied to the gradient to modify the gradient can be sampled from a noise function (e.g., distribution) having variance to satisfy a target level of differential privacy. The optimization process can modify parameters of the machine learning model, such as weights or biases, responsive to the clipping and/or modifying of the gradient. The updating of the machine learning model can be performed iteratively using multiple data instances, such as by using multiple batches of data instances (and corresponding multiple training data points from each respective data instance).

The method 300, at block B306, includes receiving an input indicating one or more features of an output to be generated using the machine learning model. The input can be received in various formats, including but not limited to text, speech, audio, image, and/or video data. For example, the input can indicate text instructions for incorporating the one or more features into text data, speech data, and/or image data of the output. The input can indicate, for example, subject matter to include in the output (e.g., as content) as well as styling (e.g., artistic styles) or other formatting features of the output. The input can be received via a user interface, which may be implemented by the same device that implements the machine learning model or a separate device from the machine learning model. For example, the input may be received via a client device that communicates the input to a server device that implements the machine learning model.

The method 300, at block B308, includes determining the output using the machine learning model and based at least on the input. For example, the machine learning model can use the denoising network to modify an initial output (which may be a randomly sampled noise data structure) into the output based at least on the input. In some implementations, the machine learning model iteratively denoises the initial output, such as by iteratively modifying the initial output according to a schedule of time points (which may correspond with (de)noise levels) until a final time point. The schedule may include a second-to-last time point having a relatively long time difference from the final time point, such as to perform iterative denoising for several noise levels (particularly relatively high noise levels), and/or one-shot deonising to the final output.

Example Content Streaming System

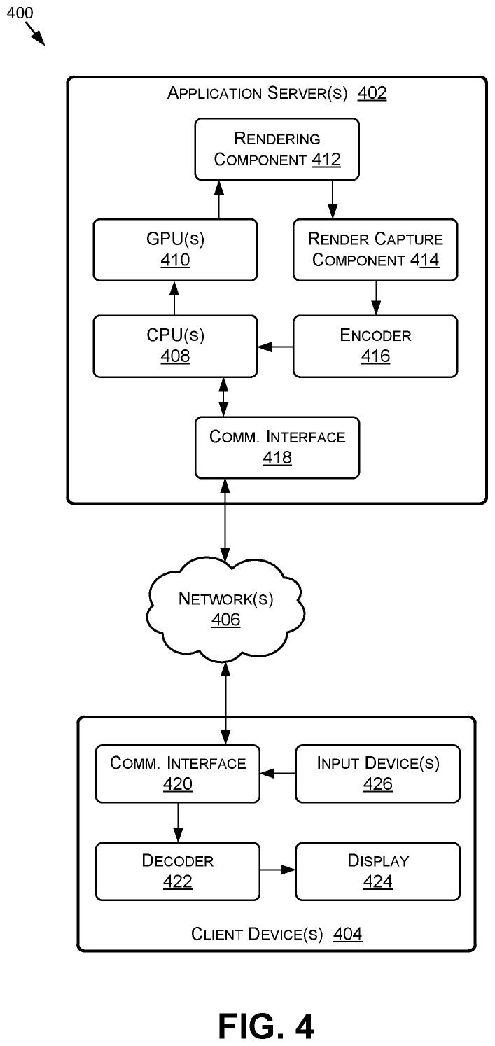

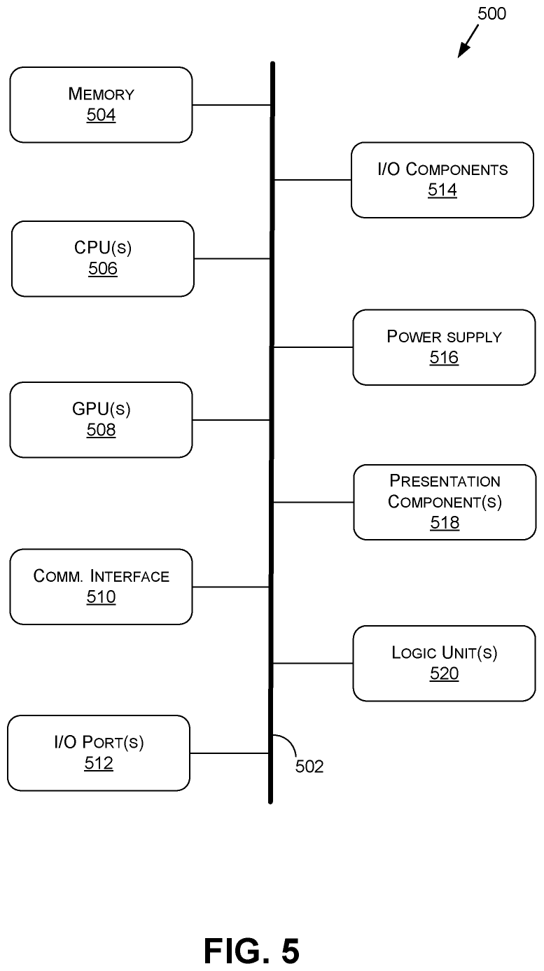

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to perform diffusion model training and runtime operations. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a diffusion model, provide the input to the model to cause the model to generate the output, and the output.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as to provide modification inputs of a driving signal for use by modifier 112. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424.

Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to generate a driving signal for use by modifier 112, or a reference image (e.g., images 104). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

Example Data Center

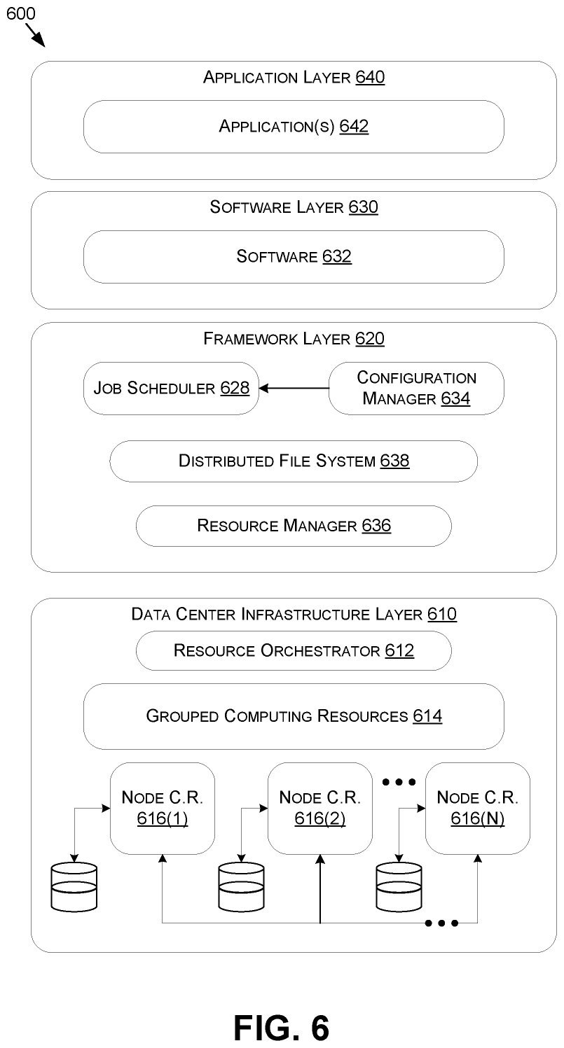

FIG. 6 illustrates an example data center 600 that may be used in at least one embodiments of the present disclosure, such as to implement the image processing system 100 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW 1/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104, 204.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train machine learning models of modifier 112) or predict or infer information using one or more machine learning models (e.g., machine learning models of modifier 112) according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
generate, using a neural network and based at least on receiving an indication of one or more features, an output corresponding to the one or more features, wherein the neural network is updated according to at least one privacy criterion; and
cause, using at least one of a display or an audio speaker device, presentation of the output.

2. The processor of claim 1, wherein the neural network comprises a diffusion model updated using at least a first training data point and a second training data point, the first training data point being determined by applying noise to a training data instance with respect to a first duration of time, and the second training data point being determined by applying noise to the training data instance with respect to a second duration of time.

3. The processor of claim 1, wherein the output comprises at least one of text data, speech data, or image data.

4. The processor of claim 3, wherein the indication comprises text instructions for incorporating the one or more features into the at least one of the text data, the speech data, or the image data.

5. The processor of claim 1, wherein the neural network is updated using a gradient descent operation that modifies one or more gradient values using noise.

6. The processor of claim 1, wherein the at least one privacy criterion corresponds to a restriction on a number of iterations of updating the network.

7. The processor of claim 1, wherein the neural network is a denoising network, and wherein the denoising network is to generate the output by:
determining an initial output according to the indication of the one or more features;
modifying the initial output for a plurality of iterations up to a predetermined denoising level to determine an intermediate output; and
determining the output in a single iteration according to the intermediate output.

8. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

9. A processor comprising:
one or more circuits to:
determine a plurality of estimated outputs using a neural network and based at least on processing a first training data point and a second training data point, wherein the first training data point is determined by applying noise to a training data instance with respect to a first duration of time, and the second training data point is determined by applying noise to the training data instance with respect to a second duration of time; and
update one or more parameters of the neural network based at least on (i) comparing the plurality of estimated outputs to a sample output corresponding to the training data instance, and (ii) at least one privacy criterion.

10. The processor of claim 9, wherein the one or more circuits are to update the one or more parameters using a gradient descent operation that modifies gradient values using noise.

11. The processor of claim 9, wherein the at least one privacy criterion corresponds to a restriction on iterations of updating the neural network.

12. The processor of claim 9, wherein:
the training data instance is a first training data instance, and a first training data set comprises the first training data instance; and
the one or more circuits are further to update the neural network using a plurality of second training data instances of a second training data set separate from the first training data set.

13. The processor of claim 9, wherein the one or more circuits are to:
apply an autoencoder to provide the training data instance in a latent data space; and
provide the training data instance from the latent data space to the neural network.

14. The processor of claim 9, wherein the neural network comprises a diffusion model.

15. The processor of claim 9, wherein the one or more circuits are to select the first duration of time and the second duration of time according to a predetermined distribution indicative of at least one of time or noise level.

16. The processor of claim 15, wherein the one or more circuits are to identify the predetermined distribution from a plurality of distributions according to the at least one privacy criterion.

17. The processor of claim 15, wherein the predetermined distribution extends between a minimum value that is greater than zero and a maximum value.

18. A method, comprising:
generating, using a neural network and based at least on receiving an indication of one or more features, an output corresponding to the one or more features, wherein the neural network is selected according to at least one privacy criterion; and
causing, using at least one of a display or an audio speaker device, presentation of the output.

19. The method of claim 18, wherein the neural network comprises a diffusion model selected using at least a first training data point and a second training data point, the first training data point being determined by applying a first amount of noise to a training data instance and the second training data point being determined by applying a second amount of noise to the training data instance.

20. The method of claim 18, wherein the output comprises at least one of text data, speech data, or image data.
